(19) United States
(12) Patent Application Publication
(10) Pub. No.: US 2025/0326549 A1
(43) Pub. Date: Oct. 23, 2025

(54) PROCESS FOR MANUFACTURING MULTI-LAYERED THIN FILM AND COSMETIC CONTAINER HAVING MULTILAYERED THIN FILM

(71) Applicant: SAMHWA CO., LTD, Uiwang-si (KR)

(72) Inventors: Kyungchang LEE, Uiwang-si (KR); SEUNG HO KIM, Yongin-si (KR); JI EUN SIM, Suwon-si (KR)

(21) Appl. No.: 18/931,917

(22) Filed: Oct. 30, 2024

(30) Foreign Application Priority Data
Apr. 19, 2024 (KR) 10-2024-0052870

(51) Int. Cl. B65D 65/42; C08J 7/04; C09D 5/00; C09D 167/02

(52) U.S. Cl. CPC B65D 65/42; C08J 7/0423; C09D 5/002; C09D 167/02; C08J 2367/02; C08J 2467/02

(57) ABSTRACT

An embodiment relates to a process for manufacturing a multi-layered thin film and a cosmetic container that includes such a multi-layered thin film. A process for manufacturing a multi-layered thin film may include: forming a primer layer on at least one substrate selected from a group consisting of PET (polyethylene terephthalate), PETG (polyethylene terephthalate glycol), PCTA, and PCTG; forming a transparent lower coating layer on the primer layer; forming an aluminum thin film layer on the lower coating layer; forming a flexible transparent intermediate coating layer on the aluminum thin film layer; and forming an upper coating layer on the intermediate coating layer.

### CROSS-REFERENCE TO RELATED APPLICATIONS

This application claims the benefit of Korean Patent Application No. 10-2024-0052870, filed with the Korean Intellectual Property Office on Apr. 19, 2024, the disclosure of which is incorporated herein by reference in its entirety.

### BACKGROUND

### 1. Technical Field

The present invention relates to a multi-layered thin film and a cosmetic container having a multi-layered thin film.

### 2. Description of the Related Art

On electronic products such as cell phones and laptops as well as cosmetic containers such as compact cases and lipstick cases, various thin films are applied on the product surface for the purpose of providing a more aesthetic exterior for the product. Such a thin film can have a sheen, such as in the case of a high-gloss or semi-gloss finish, and can have a color, ranging from transparent to opaque. Also, a thin film formed on the surface of an electronic product or a cosmetic container can include a metallic layer, which can give the product a more sophisticated look. Cosmetic cases in particular are required to provide a more ornate appearance for a product due to consumer trends, and as such, there is an especially great preference for metallic thin films.

The conventional multi-layered thin film containing metal entails the problem of being easily damaged due to its brittleness, for example when the product is dropped. Such damage is identified as being caused by the product's brittleness, which in turn is caused by the forming of the metallic thin film. Since cosmetic containers are frequently subjected to drops, there is a great need to resolve this problem.

### SUMMARY OF THE INVENTION

An aspect of the present invention, which was conceived to resolve the problem described above, is to provide a process for manufacturing a multi-layered thin film having impact resistance and a cosmetic container that includes such a multi-layered thin film.

Other objectives of the present invention will be more clearly understood from the embodiments set forth below.

One aspect of the invention provides a process for manufacturing a multi-layered thin film. The process may include: forming a primer layer on at least one substrate selected from a group consisting of PET (polyethylene terephthalate), PETG (polyethylene terephthalate glycol), PCTA, and PCTG; forming a transparent lower coating layer on the primer layer; forming an aluminum thin film layer on the lower coating layer; forming a flexible transparent intermediate coating layer on the aluminum thin film layer; and forming an upper coating layer on the intermediate coating layer.

A process for manufacturing a multi-layered thin film according to an embodiment of the present invention can include one or more of the following features. For example, the aluminum thin film layer can have a color. Also, the upper coating layer can be formed from a high-gloss material.

Another aspect of the invention provides a cosmetic container having a multi-layered thin film. The cosmetic container may be formed with at least one substrate selected from a group consisting of PET (polyethylene terephthalate), PETG (polyethylene terephthalate glycol), PCTA, and PCTG, and the cosmetic container may include: a primer layer formed on the substrate; a transparent lower coating layer formed on the primer layer; an aluminum thin film layer formed on the lower coating layer; a flexible transparent intermediate coating layer formed on the aluminum thin film layer; and an upper coating layer formed on the intermediate coating layer.

A cosmetic container having a multi-layered thin film according to still another aspect of the invention may be formed with at least one substrate selected from a group consisting of PET (polyethylene terephthalate), PETG (polyethylene terephthalate glycol), PCTA, and PCTG, and the cosmetic container may include: a primer layer formed on the substrate; an aluminum thin film layer formed on the primer layer; a flexible transparent intermediate coating layer formed on the aluminum thin film layer; and an upper coating layer formed on the intermediate coating layer.

In a cosmetic container according to an embodiment of the invention, the upper coating layer can have scratch resistance and chemical resistance.

An embodiment of the present invention having the features above can provide various advantageous effects including the following. However, an embodiment of the present invention may not necessarily exhibit all of the effects below.

An embodiment of the present invention can provide a process for manufacturing a multi-layered thin film having impact resistance and a cosmetic container that includes such a multi-layered thin film.

### BRIEF DESCRIPTION OF THE DRAWINGS

FIG. 1 is a flowchart illustrating a process for manufacturing a multi-layered thin film according to an embodiment of the invention.

FIG. 2 is a cross-sectional view of a cosmetic container on which is formed a multi-layered thin film according to a first embodiment of the invention.

FIG. 3 is a cross-sectional view of a cosmetic container on which is formed a multi-layered thin film according to a second embodiment of the invention.

### DETAILED DESCRIPTION OF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed by the present invention. In the description of the present invention, certain detailed explanations of the related art are omitted if it is deemed that they may unnecessarily obscure the essence of the invention.

The terms used in the present specification are merely used to describe particular embodiments and are not intended to limit the present invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added.

While such terms as “first” and “second,” etc., can be used to describe various components, such components are not to be limited by the above terms. The above terms are used only to distinguish one component from another.

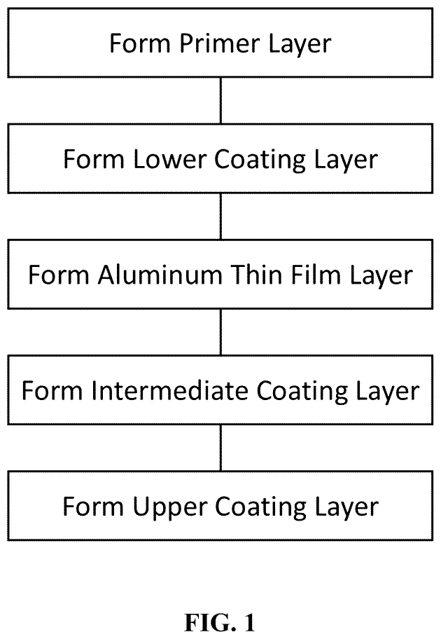

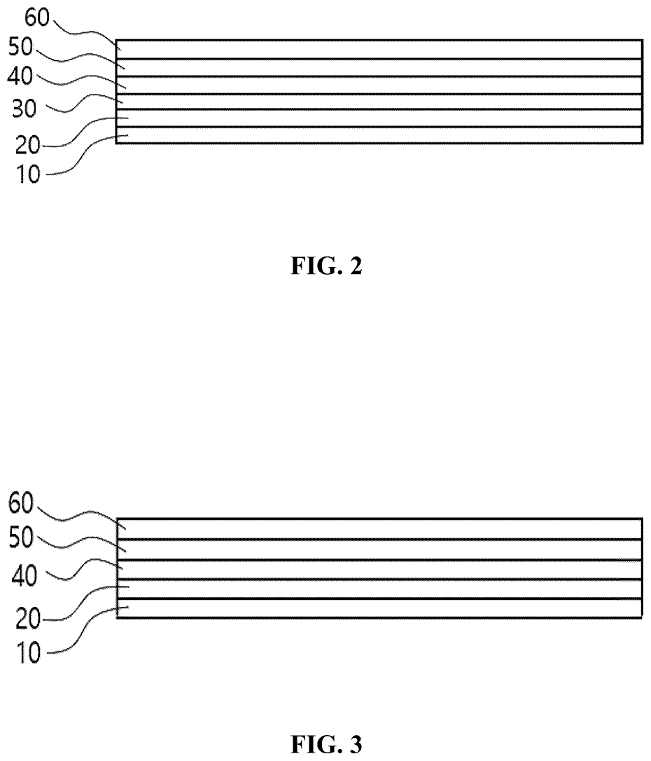

Certain embodiments of the present invention will be described below in more detail with reference to the accompanying drawings. Those components that are the same or are in correspondence are rendered the same reference numeral, and redundant descriptions are omitted. FIG. 1 is a flowchart illustrating a process for manufacturing a multi-layered thin film according to an embodiment of the invention. FIG. 2 and FIG. 3 are cross-sectional views of cosmetic containers on which multi-layered thin films are formed according to a first embodiment and a second embodiment of the invention.

Referring to FIG. 1, a process for manufacturing a multi-layered thin film according to an embodiment of the invention may include forming a primer layer 20 on at least one substrate 10 selected from PET (polyethylene terephthalate), PETG (polyethylene terephthalate glycol), PCTA, and PCTG; forming a transparent lower coating layer 30 on the primer layer 20; forming an aluminum thin film layer 40 on the lower coating layer 30; forming a flexible and transparent intermediate coating layer 50 on the aluminum thin film layer 40; and forming an upper coating layer 60 on the intermediate coating layer 50.

The substrate 10 can be made from at least one material selected from PET (polyethylene terephthalate), PETG (polyethylene terephthalate glycol-modified), and PCTA and PCTG, which are copolyester materials.

PET is a polyester resin having a relatively high density and is a crystalline and thermoplastic plastic. PET displays desirable thermal properties and dimensional stability, including high creep strength and low moisture absorption, and thus provides high hardness, high stiffness, high strength, superb sliding properties, and high wear resistance. PET does not break easily, has high transparency, and is glossy.

PETG is a thermoplastic polyester that provides chemical resistance, durability, and formability. PETG is a modified version of PET, with additions made at the molecular level to provide various chemical properties and also enhance the strength, durability, and impact resistance of the material compared to PET. PETG can be more suited to high temperatures.

PCTG is a copolyester plastic material that can be molded into pipes or other various profiles. A product made from PCTG is hard, transparent, and glossy, and can be easily subjected to molding and post-processing. PCTG also provides superb chemical resistance and impact resistance.

PCTA is a copolyester plastic material having high transparency, superb low-temperature toughness, high thermal resistance, and high processability. Also, PCTA provides superb chemical resistance, allows easy printing, coloring, and electroplating, and provides a toughness level that is three times as high as that of transparent ABS.

The substrate 10 can be used to form a cosmetic container, especially the outer body of the cosmetic container. Reference to a cosmetic container is intended to include compact cases, jar type containers, bottle-shaped containers, lipsticks, pumping containers, etc., and the present invention is not limited by the shape or usage, etc., of the cosmetic container.

A primer layer 20 can be formed over the substrate 10. The primer layer 20 allows the aluminum metal layer 40 to be securely attached to the substrate 10. The primer layer 20 can be formed in a nano-level thickness (e.g., 1 to 100 nm) and can be deposited by a plasma-assisted (ion assisted) deposition method during vacuum deposition, so that the properties of a hardened membrane may be obtained for increasing the adhesion of the lower coating layer 30 or aluminum metal layer 40 that is placed above.

The lower coating layer 30 formed on the primer layer 20 is a layer for increasing the adhesion of the aluminum metal layer 40 and, in certain embodiments, can be omitted as necessary. The lower coating layer 30 can have a transparent property and can display a matte or a glossy property.

A carbon-based compound having one or more functional groups selected from carboxyl groups, phosphate groups, silane groups, amine groups, hydroxyl groups, aldehyde groups, ketone groups, ether groups, and ketal groups can be used for the lower coating layer 30. The compound can have, but is not limited to, a molecular weight of 100 to 10,000.

The aluminum thin film layer 40 can be formed in a nano-level thickness (e.g., 1 to 100 nm) and can be transparent or colored, for example in a gold or silver color. The aluminum thin film layer 40 can be a single layer of aluminum that is formed by using an electron beam or a resistance heat apparatus within a vacuum depositor. Vacuum deposition methods include physical vapor deposition (PVD) and chemical vapor deposition (CVD), where physical vapor deposition methods can further be divided into methods using evaporation, sputtering, and ion plating.

The aluminum thin film layer 40 offers the advantages of having an aesthetic color and being relatively less prone to discoloration caused by atmospheric corrosion. The aluminum thin film layer 40 has a low density and has desirable properties in terms of processability, corrosion resistance, and thermal conductivity. The aluminum thin film layer 40 having such properties may be exposed to the exterior of the cosmetic container, so that its color or sheen may increase the aesthetic value of the product.

The intermediate coating layer 50 can have a transparent property, in order that the aluminum thin film layer 40 may be observable from the outsider. The intermediate coating layer 50 may also serve to increase the adhesion between the upper coating layer 60 described below and the aluminum thin film layer 40. The intermediate coating layer 50 can have a high-gloss, semi-gloss, or matte quality and can be a flexible layer. Also, the intermediate coating layer 50 can have scratch resistance to protect the aluminum thin film layer 40 formed below it.

A carbon-based compound having one or more functional groups selected from carboxyl groups, phosphate groups, silane groups, amine groups, hydroxyl groups, aldehyde groups, ketone groups, ether groups, and ketal groups can also be used for the intermediate coating layer 50, where the molecular weight can be 100 to 10,000.

The upper coating layer 60 is a thin film formed over the intermediate coating layer 50 and protects the aluminum thin film layer 40 by providing saltwater resistance, wear resistance, scratch resistance, etc., for increasing reliability while also providing fouling resistance (fingerprint resistance) and allowing easy cleaning. The upper coating layer 60 can have a flexible or a rigid property and can have any one sheen property of high-gloss, semi-gloss, or matte.

A process for manufacturing a multi-layered thin film according to this embodiment may be characterized by forming the intermediate coating layer 50 and the upper coating layer 60 over the aluminum thin film layer 40 so as to increase impact resistance in the substrate 10 formed with a material such as PET, PETG, PCTA, PCAG, etc. That is, in the conventional cosmetic container made from a PET material, only one high-gloss layer is formed over the aluminum thin film layer, so that the substrate may break when an impact is applied due to a drop, etc. The process for manufacturing a multi-layered thin film according to this embodiment resolves this problem and improves the impact resistance performance of the substrate 10 by forming an intermediate coating layer 50 and an upper coating layer 60 over an aluminum thin film layer 40.

FIG. 2 and FIG. 3 are cross-sectional views of cosmetic containers on which multi-layered thin films are formed according to a first and a second embodiment of the invention.

Referring to FIG. 2, a primer layer 20, a lower coating layer 30, an aluminum thin film layer 40, an intermediate coating layer 50, and an upper coating layer 60 may be formed on the substrate 10 of the cosmetic container. The properties and forming method of each thin film layer 20, 30, 40, 50, 60 are as described above with reference to FIG. 1 and thus are not repeated here.

A cosmetic container having a multi-layered thin film according to a first embodiment of the invention can have the intermediate coating layer 50 and the upper coating layer 60 formed on the aluminum thin film layer 40 and can thus prevent the substrate 10, which may be formed with any one of PET, PETG, PCTA, and PCTG and over which the metallic aluminum thin film layer 40 is formed, from being easily damaged.

In the cosmetic container shown in FIG. 3, a primer layer 20, an aluminum thin film layer 40, an intermediate coating layer 50, and an upper coating layer 60 are formed on substrate 10, and the lower coating layer 30 is omitted. That is, a cosmetic container having a multi-layered thin film according to the second embodiment of the invention can have the aluminum thin film layer 40 formed on the primer layer 20, and the intermediate coating layer 50 and upper coating layer 60 for preventing damage due to brittleness can be formed over the aluminum thin film layer 40.

While the foregoing provides a description with reference to an embodiment of the present invention, it should be appreciated that a person having ordinary skill in the relevant field of art would be able to make various modifications and alterations to the present invention without departing from the spirit and scope of the present invention set forth in the scope of claims below.

What is claimed is:

1. A process for manufacturing a multi-layered thin film, the process comprising:
forming a primer layer on at least one substrate selected from a group consisting of PET (polyethylene terephthalate), PETG (polyethylene terephthalate glycol), PCTA, and PCTG;
forming a transparent lower coating layer on the primer layer;
forming an aluminum thin film layer on the lower coating layer;
forming a flexible transparent intermediate coating layer on the aluminum thin film layer; and
forming an upper coating layer on the intermediate coating layer.

2. The process for manufacturing a multi-layered thin film according to claim 1, wherein the aluminum thin film layer has a color.

3. The process for manufacturing a multi-layered thin film according to claim 1, wherein the upper coating layer is formed from a high-gloss material.

4. A cosmetic container having a multi-layered thin film, the cosmetic container formed with at least one substrate selected from a group consisting of PET (polyethylene terephthalate), PETG (polyethylene terephthalate glycol), PCTA, and PCTG, the cosmetic container comprising:
a primer layer formed on the substrate;
a transparent lower coating layer formed on the primer layer;
an aluminum thin film layer formed on the lower coating layer;
a flexible transparent intermediate coating layer formed on the aluminum thin film layer; and
an upper coating layer formed on the intermediate coating layer.

5. A cosmetic container having a multi-layered thin film, the cosmetic container formed with at least one substrate selected from a group consisting of PET (polyethylene terephthalate), PETG (polyethylene terephthalate glycol), PCTA, and PCTG, the cosmetic container comprising:
a primer layer formed on the substrate;
an aluminum thin film layer formed on the primer layer;
a flexible transparent intermediate coating layer formed on the aluminum thin film layer; and
an upper coating layer formed on the intermediate coating layer.

6. The cosmetic container having a multi-layered thin film according to claim 4, wherein the upper coating layer has scratch resistance and chemical resistance.

7. The cosmetic container having a multi-layered thin film according to claim 5, wherein the upper coating layer has scratch resistance and chemical resistance.
